(19) United States
(12) Patent Application Publication
(10) Pub. No.: US 2015/0283879 A1
(43) Pub. Date: Oct. 8, 2015

(54) Automatic Cabin Temperature Control for Unattended Vehicle Application

(71) Applicant: Danny Tjandra, Houston, TX (US)

(72) Inventor: Danny Tjandra, Houston, TX (US)

(21) Appl. No.: 14/245,383

(22) Filed: Apr. 4, 2014

(51) Int. Cl. B60H 1/00

(52) U.S. Cl. CPC B60H 1/00778; B60H 1/00878; B60H 1/00978; B60H 1/00985

(57) ABSTRACT

The cabin's temperature of any Vehicles that are parked outdoor is very dependant to weather conditions; hence it can become very hot or very cold. Controlling the temperature manually, by turning on the engine via remote control, also have its own problem because the signal, where the car is parked or where the operator is located, could have too much radio interference and/or too far from each other. This invention offers an automatic way to regulate the cabin temperature of the parked vehicle, without user intervention.

### SUMMARY

Briefly, this invention offers a new apparatus that allows automatic temperature control of the cabin while the vehicle is unattended. This apparatus also provides a modern way of remote operation and monitoring by the use internet and wireless technology.

This invention can be implemented as standalone unit. In the future, it can also be offered as a part of other larger unit such as security system/keyless entry, built-in weather control, etc.

### DESCRIPTION OF DRAWINGS

The drawings, shown it the previous section, are provided to better illustrate the invention:

FIG. 1 is a block diagram, showings how the each components of the invention are inter-connected. Block 101-103 show the simplified representation of the vehicle, and are not the part of the invention.

FIG. 2 is an example of the flow diagram, depicting the simplified closed loop version of the control software. This flow diagram will be implemented as a firmware running in block 107 of FIG. 1.

### BACKGROUND OF INVENTION

1. Field of Invention

The present invention relates to a method, system, and apparatus for automatically maintaining the cabin temperature inside parked automotive vehicle.

2. Description of Prior Art

Almost all modern automotive vehicles have weather control system in the form of heating and cooling system. But such system only operates when the vehicle is being used.

Inventor found that there is no available equipment that can automatically controls the vehicle's cabin temperature. This equipment can be used, but not limited in the following condition:
When there is pet in the vehicle
When there is/are food in the vehicle that is prone to high temperature.
When there is/are medication in the vehicle that will spoil when exposed to high temperature.
When the car had been parked and/or exposed by hot or cold weather for long period.
Etc.

The closest prior art of this invention are remote start systems. But they require remote operator to manually turn the engine on, hence also turn on the weather control system in the car. This solution poses problems depending on the connection method, where the vehicle is parked and where the operator is located. Bluetooth, OOK, or any other direct point to point solution wireless has limited range. Wireless internet (GSM/CDMA), or text-massages based require that both the vehicle and the operator has access at the same time, in which can be challenging in certain area/building.

### DESCRIPTION OF THE PREFERRED EMBODIMENT

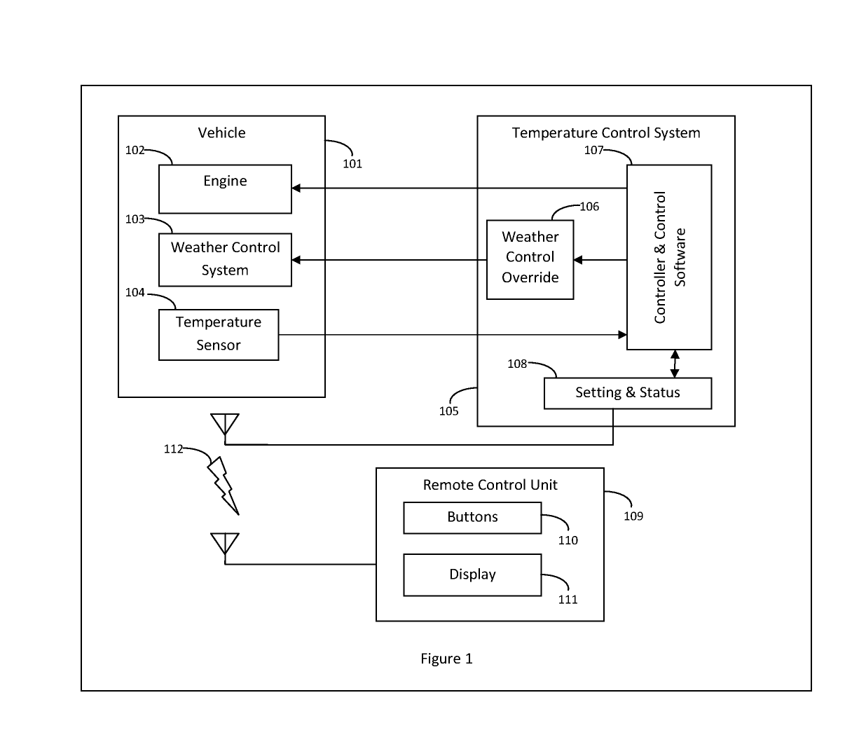

Referring to FIG. 1, the Temperature Control System 107 gathers the temperature data from Vehicle 101, by using one or more temperature sensors 104. The control software, running in 107, compares the temperature reading with the user setting 108, and decides if the cabin temperature is within the desired range.

When the cabin temperature is out of the desired range and the user setting 108 indicates that the weather control system 103 can be overridden, the controller 107 should decide the correct course of action by overriding the weather control setting. The controller 107 will also power-on the vehicle system by turning-on the battery, and start the engine 102 when necessary.

The controller will also monitor the functionality of the system by comparing the temperature reading from the sensor 104 over period of time to make sure that the cabin temperature is moving toward the desired direction. It will shut down the weather control system when the cabin temperature goes to the wrong direction. A second sensor can be installed at the air output port of the vehicle, to detect if the weather control system produced the correct air temperature relative to the cabin's temperature.

The Control system 107 will store all of the system status, action, and log file in 108, which can be queried by the Remote Control Unit 109 and shown in the display unit 111. When an error condition occurs, the control system 107 can warn selected remote user(s) for immediate response via text messages or any internet based method such as email, tweets, messaging-client, etc. Though this method depends on the availability of GSM/CDMA internet access, but it doesn't require both the vehicle and the user to have access to the internet at the same time.

Remote Control Unit 109 can consist of single or multiple devices, and communicates with the Temperature Control Systems 105 by using standard wireless link 112 such as GSM/CDMA modem, text-messages, Wifi-ethernet, Bluetooth, or OOK (on-off keying). The wireless connection can be point-to point and/or via hosted-server.

The Remote Control Units 109 might have buttons/virtual-buttons 110 and/or display 111. The buttons are used to control the user settings which are eventually stored in the 108 of the Temperature Control Unit 105. The buttons are also used to activate or inactivate the system. The display 111 might consist of leds and/or LCD/TFT display. The Remote Control unit 109 can easily be implemented in modern smart-phone and/or tablet. The temperature control system 105 can implement a web server to allow any internet-enabled device, such as computer, tablet, smart-phone, gaming console, etc, to be used as the Remote Control unit.

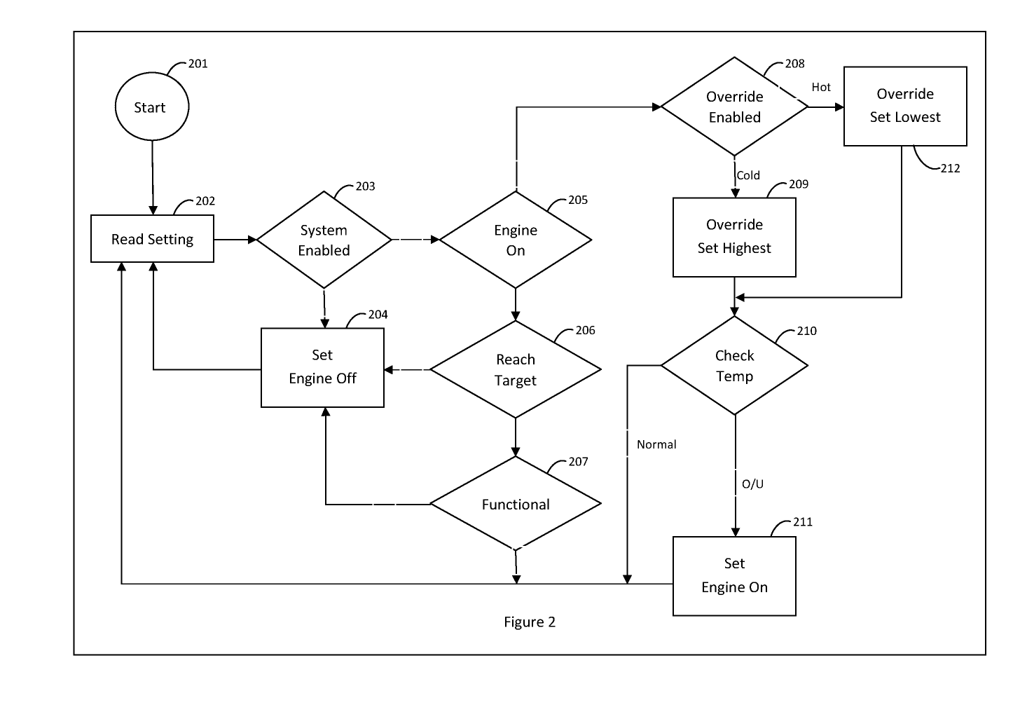

FIG. 2 show an example of the closed-loop part of the control software that is running in the Controller 107. The starting point 201 represents the initialization. All user settings is read in block 202. In step 203, the engine is guaranteed to be off in 204 when the control system is disabled by the user.

Step 205 checks if the engine is running. When the engine is running, it will wait until the target temperature has been reach in step 206, or error condition is detected in step 207, before turning the engine off in step 204. When the engine is not currently running, it will monitor the temperature in step 208 and 210, and activates the weather control and the engine in step 211, when necessary.

What is claimed are:

1. The electronic apparatus, that can automatically control the vehicle's cabin temperature. This device has input from the temperature sensor, and setting provided by the user. It has outputs that control the vehicle's battery power, engine power, and optionally the weather control system.

2. The electronics/elecro-mechanical apparatus of claim 1, that provide controls to the weather control system in the vehicle. This device overrides the weather control systems, when necessary. This device also automatically controls/select s the use of heating or refrigeration system, and the temperature setting.

3. The method of claim 1, that automatically start/stop the engine or power system in a car, when heating/cooling is required to maintain cabin temperature.

4. The method of claim 1, that automatically detects the error condition, in which, the change temperature change in the wrong direction and automatically shut down the system.

5. The method of claim 1, that uses second sensor located to measure the air output of the vehicle's weather control system, to detect error condition and automatically shutdown the system.

6. The embedded web server of claim 1, that when coupled with GSM/CDMA connection, allows access from any internet enabled devices.

7. The method of claim 1, that when coupled with GSM/CDMA and/or Text massages, allows hosted web-server to be used as intermediary access-point to the Remote Control Unit and/or any internet enabled devices.

8. The method of claim 1, implemented as standalone unit or a part of larger system such as built-in weather control or security system.

9. The method of claim 1, that delivers error condition to the user with different method that doesn't require apparatus of claim 1 having direct access to the remote display of claim 2.

10. The wireless apparatus that is used to control the functionality of the device of claim 1.

11. The usage of Bluetooth, GSM/CDMA, Test-messages, and/or OOK (on-off keying) wireless technology to gain point to point access between apparatuses of claim 7 and claim 1.

12. The usage of the apparatus of claim 7, to program the desired setting and monitor the status/activity of the apparatus of claim 1.

13. Enabling or disabling the functionality of the apparatus of claim 1.

14. Selects the temperature in which the apparatus will automatically turns on or off. This might include the ability to control the setting of the weather control system in the vehicle.

15. The use of modern wireless communication to deliver messages among users, remote controller claimed in 10, and temperature controller claimed in 1.

16. The method of claim 14, that uses of Bluetooth to deliver messages point to point to devices such as tablet and/or smart phone over short distance.

17. The method of claim 14, that uses GSM/CDMA modem to provide internet connection, with either point to pint communication to the remote devices, or to the hosted intermediary server.

18. The method of claim 14, that uses email, text message, and/or Internet messaging system to deliver warning or to request intervention when error condition is detected.
